(19) United States
(12) Patent Application Publication
(10) Pub. No.: US 2013/0036428 A1
(43) Pub. Date: Feb. 7, 2013

(54) EVENT TRIGGERING METHOD DURING SLEEP MODE AND RELATED MOBILE DEVICES

(71) Applicants: Yu-Hsiang Lei, Taoyuan County (TW); Yen-Ying Huang, Taoyuan County (TW)

(72) Inventors: Yu-Hsiang Lei, Taoyuan County (TW); Yen-Ying Huang, Taoyuan County (TW)

(21) Appl. No.: 13/524,163

(22) Filed: Jun. 15, 2012

Related U.S. Application Data
(60) Provisional application No. 61/514,367, filed on Aug. 2, 2011.

(51) Int. Cl. G06F 9/46

(52) U.S. Cl. 719/318

(57) ABSTRACT

An event triggering method for triggering events during a sleep mode for use in a mobile device is provided, wherein events includes at least first and second type events. First, an event manager operated in the sleep mode is provided, wherein event manager includes a counter. Thereafter, second type event registers to event manager a periodical time period. Upon receiving a request for triggering the first type event, it is determined whether to trigger second type event together with triggered first event according to a counter value counted by the counter and time period registered by the second type event; wherein second type event is determined as not being triggered when counter value is less than time period registered by second type event and second type event is determined as being triggered when counter value is equal to or exceeds time period registered by second type event.

### CROSS REFERENCE TO RELATED APPLICATIONS

This Application claims priority of U.S. Provisional Application No. 61/514,367, filed on Aug. 2, 2011, and the entirety of which is incorporated by reference herein.

### BACKGROUND OF THE INVENTION

1. Field of the Invention

The invention generally relates to mobile devices and event management methods thereof, and more particularly to event triggering methods for triggering events during a sleep mode in mobile devices.

2. Description of the Related Art

Recently, portable devices, such as handheld devices, have become more and more technically advanced and multifunctional. For example, a handheld device may receive email messages, have an advanced address book management application, allow media playback, and have various other functions. Because of the conveniences of devices with multiple functions, the devices have become necessities of life.

Current portable devices, such as smart phone, PDA (Personal Digital Assistant) and/or tablet PC, have limited power supply which is limited by the battery capacity. Sleep mode is a state in which puts portable device into so called low power mode, and is a key point to make battery life longer. Under the sleep mode of mobile devices, some non-real time and periodic events, such as battery information update or weather update, may wake up the device and consume some power. These events usually have different periodical intervals and do not wake up altogether. Those periodic events are essential and necessary to provide some services to user even when the device is under sleep mode. However, it is unavoidable for these periodic events to impact the power consumption.

### BRIEF SUMMARY OF THE INVENTION

Accordingly, embodiments of the invention provide event triggering methods for triggering events during a sleep mode in a mobile device, wherein the events comprises at least one first type events and at least one second type events. In one aspect of the invention, an event triggering method for triggering events during a sleep mode in a mobile device is provided. First, an event manager operated in the sleep mode is provided, wherein the event manager comprises a counter. Thereafter, each second type event registers to the event manager a periodical time period. Upon receiving a request for triggering the first type event, it is determined whether to trigger the second type event together with the triggered first type event according to a counter value counted by the counter and the time period registered by the second type event; wherein the second type event is determined as not being triggered in response to the counter value being less than the time period registered by the second type event and the second type event is determined as being triggered in response to the counter value being equal to or exceeding the time period registered by the second type event.

In another aspect of the invention, a mobile device is provided which comprises an event manager operated in a sleep mode and comprises a counter. The event manager for triggering events during the sleep mode, wherein the events comprises at least first type events and second type events, wherein the event manager accepts a registration of a periodical time period from each second type event and upon receiving a request for triggering one of the first type events, determines whether to trigger any of the second type events together with the triggered first type event according to a counter value counted by the counter and the time period registered by each second type event, wherein the second type event is determined as not being triggered in response to the counter value being less than the time period registered by the second type event and the second type event is determined as being triggered in response to the counter value being equal to or exceeding the time period registered by the second type event.

In another aspect of the invention, an event triggering method for triggering events during a sleep mode in a mobile device is provided. An interrupt for triggering a first event is first received. It is then determined whether to trigger a second event together with the first event according to a counter value from a time point the second event is previously triggered to a current time point. Operation corresponding to the first event and the second event are performed in response to the second event being determined to be triggered.

Other aspects and features of the present invention will become apparent to those with ordinarily skill in the art upon review of the following descriptions of specific embodiments of event triggering methods for triggering events during a sleep mode for use in a mobile device.

### BRIEF DESCRIPTION OF DRAWINGS

The invention can be more fully understood by reading the subsequent detailed description and examples with references made to the accompanying drawings, wherein:

FIG. 1 is a block diagram illustrating a mobile device according to an embodiment of the invention;

FIG. 2 is a schematic diagram illustrating an embodiment of events that are required to be triggered during the sleep mode of the mobile device of the invention;

FIG. 3 is a flow chart illustrating an event triggering methods for triggering events during a sleep mode for use in a mobile device according to an embodiment of the invention;

FIG. 4 is a schematic diagram illustrating another embodiment of events of FIG. 2 that are triggered during the sleep mode of the mobile device after applying the event triggering method of the invention;

FIG. 5 is a flow chart illustrating an event triggering methods for triggering events during a sleep mode for use in a mobile device according to another embodiment of the invention;

FIG. 6 is a schematic diagram illustrating another embodiment of events that are triggered during the sleep mode of the mobile device of the invention; and

FIG. 7 is a schematic diagram illustrating another embodiment of events of FIG. 6 that are triggered during the sleep mode of the mobile device after applying the event triggering method of the invention.

### DETAILED DESCRIPTION OF THE INVENTION

The following description is of the best-contemplated mode of carrying out the invention. This description is made for the purpose of illustrating the general principles of the invention and should not be taken in a limiting sense.

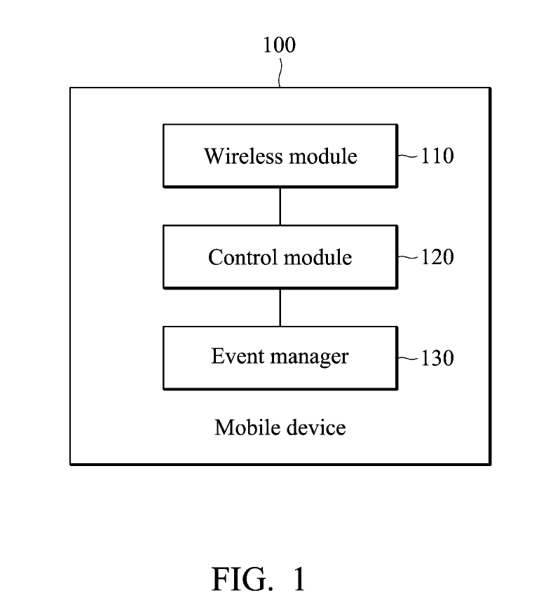

FIG. 1 is a block diagram illustrating a mobile device according to an embodiment of the invention. The mobile device 100 may be handheld devices, such as a PDA (Personal Digital Assistant), a smart phone, a mobile phone, an MID (Mobile Internet Device, MID), a laptop computer, a car computer, a digital camera, a multi-media player, a gaming device, or any other type of mobile computational device. However, it is to be understood that the invention is not limited thereto. In this embodiment, the mobile device 100 is wirelessly connected to a cellular station of a service network (not shown) for obtaining wireless services. The mobile device 100 comprises a wireless module 110 for performing the functionality of wireless transmissions and receptions to and from the cellular station. To further clarify, the wireless module 110 may comprise a baseband unit (not shown) and a radio frequency (RF) unit (not shown). The baseband unit may contain multiple hardware components to perform baseband signal processing, including analog to digital conversion (ADC)/digital to analog conversion (DAC), gain adjusting, modulation/demodulation, encoding/decoding, and so on. The RF unit may receive RF wireless signals, convert the received RF wireless signals to baseband signals, which are processed by the baseband unit, or receive baseband signals from the baseband unit and convert the received baseband signals to RF wireless signals, which are later transmitted. The RF unit may also contain multiple hardware components to perform radio frequency conversion. For example, the RF unit may comprise a mixer to multiply the baseband signals with a carrier oscillated in the radio frequency of the mobile communications system, wherein the radio frequency may be 900 MHz, 1900 MHz, or 2100 MHz utilized in WCDMA systems, or may be 900 MHz, 2100 MHz, or 2.6 GHz utilized in LTE systems, or others depending on the radio access technology (RAT) in use. Also, the mobile device 100 further comprises a control module 120 for controlling the operation of the wireless module 110 and other functional components, such as display unit and/or keypad serving as the MMI (man-machine interface), a storage unit storing the program codes of applications or communication protocols, or others.

The mobile device 100 may be operated in a normal mode or a sleep mode. When the mobile device 100 is operated in the normal mode, the mobile device 100 is in a normal state and powers of all its modules are turned on by the control module 120 so the mobile device 100 is capable of performing all operations, however, the power consumption will be significantly huge. During the sleep mode of the mobile device 100, the mobile device 100 is in a sleep state and power for many modules unnecessary to perform operations are turned off and only power for few necessary modules remain turned on by the control module 120 so as to receive input from an input device (not shown) and to save power.

As aforementioned, some non-real time and periodic events, such as battery information update or weather update, may wake up the mobile device 100 from sleep state to normal state for handling the events during the sleep mode and consume some power. Some of those periodic events are essential and necessary to provide services even when the mobile device 100 is under the sleep mode.

During the sleep mode of the mobile device 100, there are events that wake up the mobile device 100 from the sleep state to the normal state. Note that the events may comprise first type events and second type events. In some embodiments, the first type events are timing-critical/real-time events that are necessary and unavoidable for the mobile device 100 and should be performed immediately and can not be delayed once any of them is issued, such as a signal strength change, incoming call from the cellular station or a user input received from the input device and so on. While the second type events are non-timing critical/non-real-time events that could be delayed within a tolerance time period, such as battery information or weather information update and widgets/applications running on the background and so on. The mobile device 100 may further comprise an event manager 130 which is responsible for accepting the registration of second type events, i.e. the non-real time and non-timing critical events, and determining when to trigger the second type events during the sleep mode. The non-real time and non-timing critical events may be issued from, for example, drivers which have non-real-time and/or non-timing critical events from a driver layer of the operating system of the mobile device 100 or applications which have non-real-time and/or non-timing critical events from an application layer of the operating system of the mobile device 100, but the invention is not limited thereto. It is understood that, the event manager 130 may be located in the driver layer of mobile device 130 to accept the registration of drivers which have non-real-time and/or non-timing critical events from the driver layer of the mobile device 100 or applications which have non-real-time and/or non-timing critical events from the application layer of the mobile device 100. Each non-real time event may register to the event manager 130 a periodical time period to indicate that it wants to be triggered during an initialization operation of the event. For example, the battery driver has such kind of event so that it may issue a registration to register its periodical time period to the event manager 130 during its driver initialization. Applications (e.g. widgets running on the background) may also issue a registration to the event manager 130 during its application initialization through a device IO control (IOCTL) command from the application layer down to the driver layer. In other words, the event manager 130 is capable of managing the triggering of the events from not only the driver layer but also the application layer of the mobile device 100 during the sleep mode. The event manager 130 can perform the event triggering method for triggering events during a sleep mode of the mobile device of the present invention, which will be discussed further in the following paragraphs.

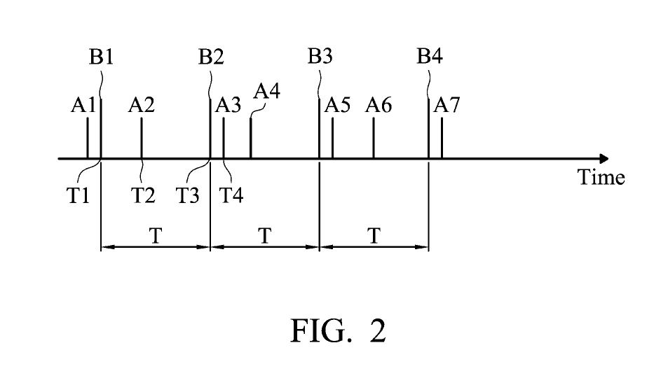

FIG. 2 is a schematic diagram illustrating an embodiment of events that are required to be triggered during the sleep mode of the mobile device of the invention. As shown in FIG. 2, assume that the horizontal axis represents time-lines of predetermined execution of the events. With the time goes, during the sleep state, there are several first type events denoted as A1, A2, . . . , and A7 and second type events denoted as B1, B2, . . . , and B4, wherein the first type events A1, A2, . . . and A7 are those events which bring the mobile device 100 out from the sleep state to the normal state, which are necessary and unavoidable for the mobile device 100 and are timing critical, such as paging events, signal strength change or incoming call from a cellular station of a service network. Note that these first type events are necessary and unavoidable to the mobile device, which are referred to as timing critical events in the invention. The second type events B1, B2, . . . , and B4 are those events which with fixed timer but are not timing critical and non-hard real-time requirement. Note that these second type events can be referred to as non-timing critical/non-real time events in the invention. Generally, there is a periodic timer between each Bi and Bi+1 as shown in FIG. 2. For example, the periodic timer may be set as 60 seconds between each Bi and Bi+1.

Referring to FIG. 2, the mobile device 100 would be waked up from the sleep mode whenever a first type event or a second type event is triggered. Since the wake-up timer of all the events has random distribution, the more number of the events are, the more power is consumed even if the mobile device 100 is operated in the sleep mode.

As previous stated, not all of the events that are required to be triggered during the sleep mode are time critical or of hard real-time requirement (e.g. the second type events Bi shown in FIG. 2). In other words, those non-timing critical events need not be triggered periodically as set by the timer, and can be delayed for a tolerable period or even skipped at certain scheduled timers. Therefore, a collective event triggering mechanism can be provided to minimize the times that the mobile device 100 being woke up from the sleep state during sleep mode.

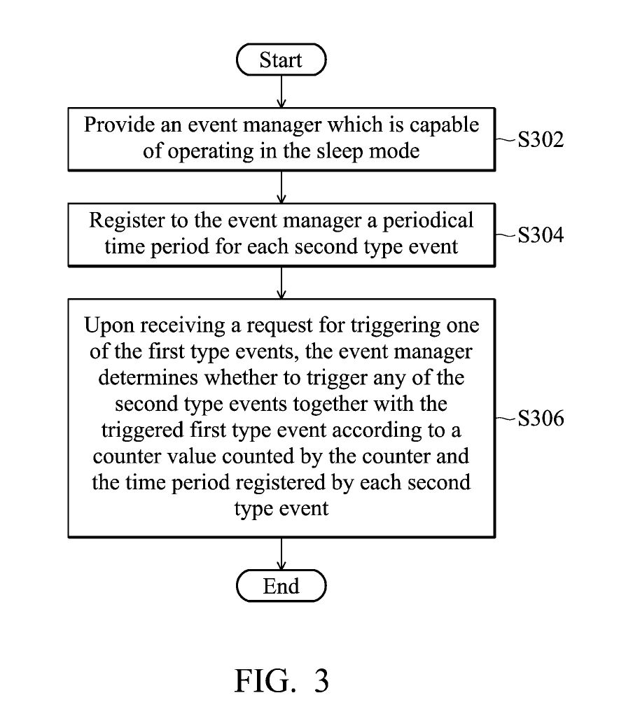

FIG. 3 is a flow chart illustrating an event management method according to an embodiment of the invention. The method can be applied to the mobile device 100 as shown in FIG. 1. The mobile device 100 may be, for example, a mobile device with a centralized controller capable of managing events required to be triggered during the sleep mode, such as a mobile phone. In this embodiment, the events to be managed comprise at least first type events (e.g. the timing critical events A shown in FIG. 2) and second type events (e.g. the non-timing critical events B shown in FIG. 2).

In step S302, an event manager 130 which is capable of operating in the sleep mode is first provided, wherein the event manager 130 has a counter. Thereafter, in step S304, each second type event registers to the event manager 130 a periodical time period. The second type events may be, for example, non-timing critical/non-real time events issued from a driver layer of the mobile device 100 and/or issued from an application layer of the mobile device 100. After receiving and accepting the registration of the responsive periodical time period from all of the second type events, the event manager 130 may maintain a registered queue that records the periodical time periods of all registered second type events.

During the sleep mode, Upon receiving a request for triggering one of the first type events, in step S306, the mobile device 100 exits the sleep state via the control module 120 and the event manager 130 further determines whether to trigger any of the second type events together with the triggered first type event according to a counter value counted by the counter and the time period registered by each second type event. In this step, the counter of the event manager 130 may count from last trigger point to current trigger point for obtaining the counter value. When the counter value is less than the time period registered by certain second type event, this second type event is determined as not being triggered since the scheduled trigger time of the second type event has not been expired. When the counter value is equal to or exceeds the time period registered by the second type event, which indicates that the scheduled trigger time of the second type event has expired, the second type event is determined as being triggered. Once the second type event is determined as being triggered, the event manager 130 will trigger the second type event together with the first type event being triggered so that the second type event may perform corresponding operation. For example, if the second type event is a battery information update event, the battery driver will be triggered via the event manager 130 such that the mobile device 100 is waked up from the sleep state to the normal state via the control module 120 to collect the battery information and update the battery status accordingly. And, after the operation of the battery driver is completed as well as the first type event being triggered together, the mobile device 100 reenters the sleep state.

In one embodiment, those non-timing critical events B can be triggered along with timing critical events A whose timer interval is similar to the non-critical events B. In another embodiment, the non-timing critical events B are not triggered when its timer is expired and it waits for the triggering of a timing critical event A for a second period of time. If a timing critical event is triggered during the second period of time, the non-timing critical event is triggered along with the triggered timing critical event. If none of the timing critical events is scheduled to be triggered, the non-critical event may be triggered at the expiration of the second period of time. In yet another example, the non-timing critical events can be skipped and wait until the next interval.

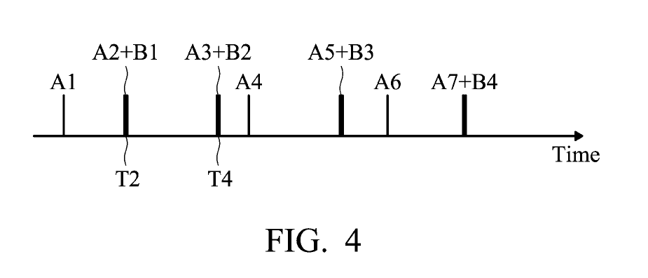

FIG. 4 is a schematic diagram illustrating another embodiment of events of FIG. 2 that are triggered during the sleep mode of the mobile device when applying with the event triggering method of the invention. By comparing FIG. 4 with FIG. 2, it can be observed that non-timing critical events Bi are not be triggered at all time. On the other hand, the event B1 will not be triggered as scheduled at time point T1. The event B1 is triggered with the closest following event, i.e., the event A2 at time point T2. At the next interval, the event B2 will be triggered following with the event A3 at time point T4 rather than the scheduled time point T3 and so forth. In this way, no non-timing critical event is triggered alone and the mobile device can be waked up from the sleep state by less times.

It is to be noted that delaying or skipping the triggering of non-timing critical events would not affect the performance or degrade the service of the mobile device. Therefore, power consumption can be saved significantly if only timing-critical and/or real-time events are exactly triggered as desired.

It is to be noted that, in some embodiments, when determining that the second type event is not being triggered, the event manager 130 may subtract the counter value of the counter from the time period registered by this second type event to obtain a subtracted time period and then configure the subtracted time period as the time period of the second type event for subsequent determination.

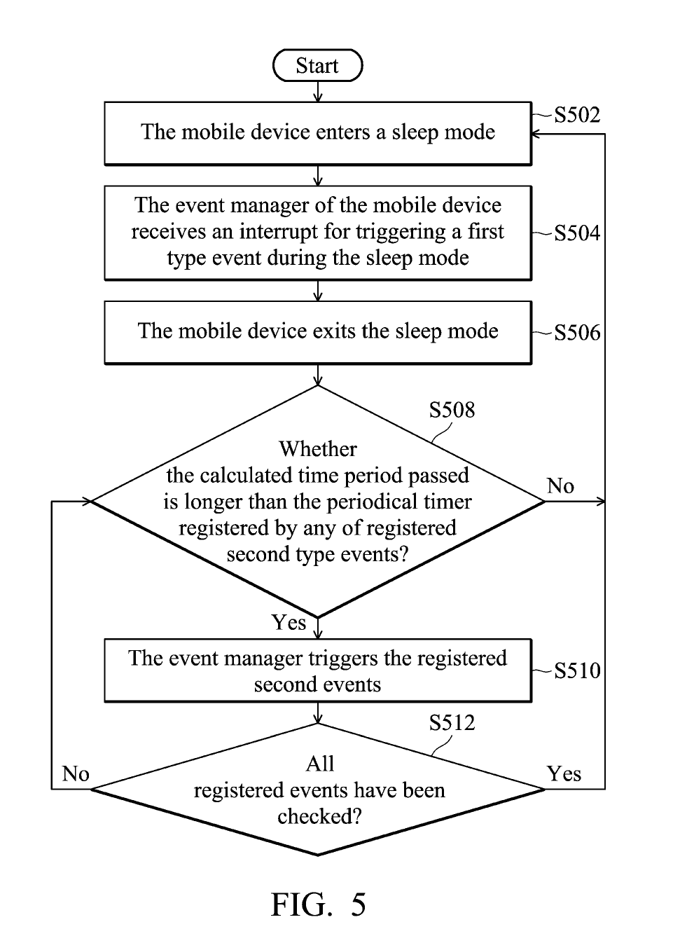

FIG. 5 is a flow chart illustrating an event management method according to another embodiment of the invention. The method can be applied to the mobile device 100 as shown in FIG. 1. The mobile device 100 may be, for example, a mobile device with the event manager 130 capable of managing events to be triggered during the sleep mode, such as a mobile phone. In this embodiment, the events to be managed comprise at least first type events (e.g. the timing critical events A shown in FIG. 2) and second type events (e.g. the non-timing critical events B shown in FIG. 2). First, the mobile device is entered into the sleep mode (step S502) and when the event manager 130 of the mobile device 100 receives an interrupt for triggering a first type event (i.e. a timing-critical/real-time event) during the sleep mode (step S504) and exits the sleep state (step S506), the event manager 130 calculates the time period passed from last trigger point (i.e. the trigger time of the previous triggered event), which may be counted by the counter, and determines whether the calculated time period passed is longer than the periodical timer registered by any of registered second type events (i.e. the non-timing critical events) (step S508). If the calculated time period passed is shorter than the periodical timer registered by the registered non-timing critical events (No in step S508), the mobile device 100 returns to the sleep state (step S502) and waits for subsequent interrupt. If so (Yes in step S508), i.e. the calculated time period passed is longer than the periodical timer registered by one or more registered non-timing critical events, those non-timing critical events will be triggered (step S510). Then, the event manager 130 further determines whether all registered events have been checked (step S512). If not all of the registered events have been checked (No in step S512), steps S508-S512 are further performed to recheck the remaining registered events which are not being checked and triggered them if needed. Once all registered events are checked and triggered if needed (Yes in step S512), then the mobile device 100 can return back to sleep state and wait for subsequent interrupt.

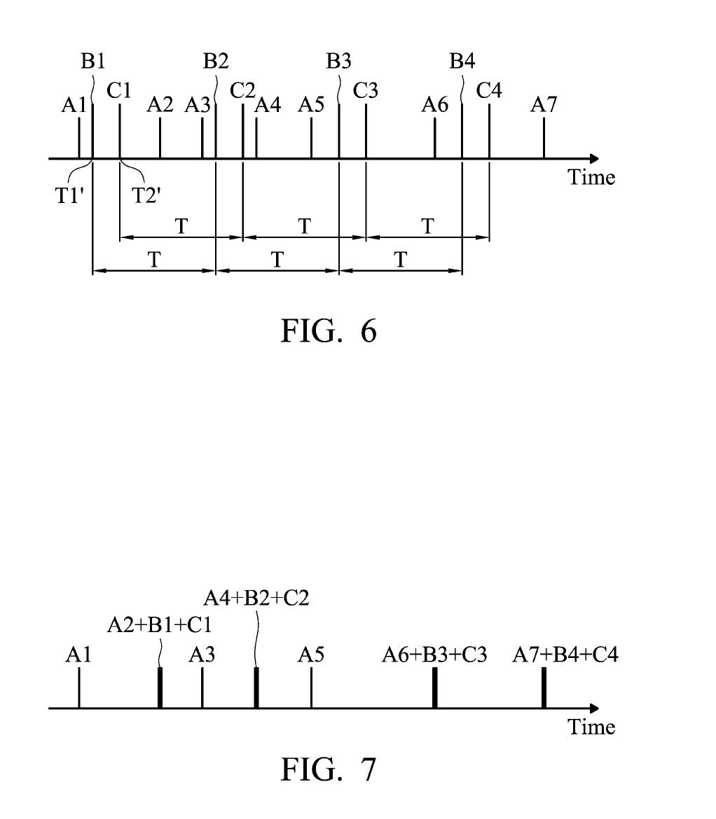

For explanation, one specific embodiment is illustrated in the following to explain the detailed process of an event triggering method of the invention, and those skilled in the art will understand that this specific embodiment is used for explanation only and the invention is not limited thereto. FIG. 6 is a schematic diagram illustrating another embodiment of events that are triggered during the sleep mode of the mobile device of the invention. In this embodiment, more than one periodical and non-timing critical events are with the same period T, however, the first trigger point of which may not be at the same time. As shown in FIG. 6, two periodical non-timing critical events, Bi and Ci with the same period T are illustrated and the first trigger points of the non-timing critical events, Bi and Ci are at time points T1′ and T2′ respectively so the first trigger points of the non-timing critical events, Bi and Ci are not at the same time. Again, with the conventional triggering mechanism, the mobile device 100 would be waked up independently for each non-timing critical event Bi and Ci even if they have the same interval T, resulting in lots of event activities and making system being waked up more frequently.

FIG. 7 is a schematic diagram illustrating another embodiment of events of FIG. 6 that are triggered during the sleep mode of the mobile device after applying the event triggering method of the invention. Referring to FIG. 7, after applying the event triggering method of the invention, the non-timing critical events Bi and Ci will be bound and be triggered together with the closest necessary event. For example, as shown in FIG. 7, the non-timing critical events B1 and C1 will be triggered along with the timing critical event A2, the non-timing critical events B2 and C2 will be trigger along with the timing critical event A4 and so on.

In some embodiments, when two or more events are to be triggered together, these events may be triggered, for example, sequentially in a time order, based on priority of each event or based on a specific sequence, but the invention is not limited thereto. For example, when the event A1 is being triggered, as the event B1 has expired earlier than the event C1, triggering of the event B1 is performed prior to that of the event C1. In another embodiment, if the event C1 has a priority higher than that of the event B1, triggering of the event C1 is performed prior to the triggering of the event B1. Priority of the second type events may be registered together with their time intervals to the event manager. In yet another embodiment, triggering of the events B1 and C1 may be performed randomly (e.g. either the event B1 or the event C1 can be first performed) or performed based on a sequence of C1 to B1 specified by the user.

In some embodiments, there may be events that are not timing critical and, however, should be performed within a certain period of time. For example, the battery driver should collect the status and information of the battery every fixed time period (e.g. 60 seconds) during the sleep mode so as to update the status and capacity of the battery. The updating of the status and capacity of the battery can not be delayed too long since the user may confuse about the actual battery capacity remained. Therefore, each event is further provided a tolerance period in which the triggering of the event should be performed together with the triggering of the closest following first type event once the triggering of the event has been delayed over a period that is longer than the tolerance period of that event.

In summary, according to the event management method for a mobile device (e.g. a mobile phone) of the invention, by using the centralized event manager, non-timing critical and periodical events can be collective triggered along with timing critical events such that no non-timing critical event is triggered alone and the mobile device can be waked up from the sleep state for less times, thus minimizing the times the mobile device being woke up from the sleep state and achieving the purpose of power saving. Moreover, the mobile device can have longer sleep without being interrupted by each non-real-time and periodical event, thereby improving the average current during the sleep mode and resulting in a batter battery life.

Event triggering methods for use in an electronic device, or certain aspects or portions thereof, may take the form of a program code (i.e., executable instructions) embodied in tangible media, such as floppy diskettes, CD-ROMS, hard drives, or any other non-transitory machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An event triggering method for triggering events during a sleep mode for use in a mobile device, wherein the events comprise at least one first type event and at least one second type event, comprising:
providing an event manager operated in the sleep mode, wherein the event manager comprises a counter;
registering to the event manager a periodical time period for the second type event; and
upon receiving a request for triggering the first type event, determining whether to trigger the second type event together with the triggered first type event according to a counter value counted by the counter and the time period registered by the second type event;
wherein the second type event is determined as not being triggered in response to the counter value being less than the time period registered by the second type event and the second type event is determined as being triggered in response to the counter value being equal to or exceeding the time period registered by the second type event.

2. The event triggering method of claim 1, wherein the first type event is timing-critical/real-time event and the second type event is non-timing critical/non-real-time event.

3. The event triggering method of claim 2, wherein the non-timing critical/non-real-time event is issued from a driver layer of the mobile device or from an application layer of the mobile device.

4. The event triggering method of claim 1, wherein the at least one second type event determined as being triggered comprise two or more events and the two or more events are sequentially triggered based on priority of the two or more events.

5. The event triggering method of claim 1, wherein the determining step further comprises:
in response to determining that the second type event is not being triggered, subtracting the counter value from the time period to obtain a subtracted time period; and
configuring the subtracted time period as the time period of the second type event for subsequent determination.

6. The event triggering method of claim 5, wherein the second type event further includes a tolerance period and the second type event is determined as being triggered together with a closest subsequent first type event in response to the triggering of the second type event has been delayed over the tolerance period.

7. The event triggering method of claim 5, wherein the periodical time period of the second type event is registered to the event manager during an initialization operation of the second type event.

8. A mobile device, comprising:
an event manager operated in a sleep mode and comprises a counter, for triggering events during the sleep mode, wherein the events comprise at least first type events and second type events,
wherein the event manager accepts a registration of a periodical time period from each second type event and upon receiving a request for triggering one of the first type events, determines whether to trigger any of the second type events together with the triggered first type event according to a counter value counted by the counter and the time period registered by each second type event, wherein the second type event is determined as not being triggered in response to the counter value being less than the time period registered by the second type event and the second type event is determined as being triggered in response to the counter value being equal to or exceeding the time period registered by the second type event.

9. The mobile device of claim 8, wherein the first type events are timing-critical/real-time events and the second type events are non-timing critical/non-real-time events.

10. The mobile device of claim 9, wherein the non-timing critical/non-real-time events comprise events issued from a driver layer of the mobile device and events issued from an application layer of the mobile device and the event manager is located on the driver layer of the mobile device for accepting the registration of the non-timing critical/non-real-time events.

11. The mobile device of claim 8, wherein the second type events that are determined as being triggered comprise at least two events and the event manager further sequentially triggers the at least two events based on priority of the at least two events or a predefined time order.

12. The mobile device of claim 8, wherein the second type event further includes a tolerance period and the event manager further determines to trigger the second type event together with a closest subsequent first type event when the triggering of the second type event has been delayed over the tolerance period.

13. The mobile device of claim 8, wherein the periodical time period of each second type event is registered to the event manager during an initialization operation of the second type event.

14. An event triggering method for triggering events during a sleep mode for use in a mobile device, comprising:
receiving an interrupt for triggering a first event;
determining whether to trigger a second event together with the first event according to a counter value from a time point the second event is previously triggered to a current time point; and
performing operation corresponding to the first event and the second event in response to the second event being determined to be triggered.

15. The method of claim 14, wherein the determining step further comprises determining whether the counter value is equal to or exceeds a predetermined time period corresponding to the second event.

16. The method of claim 15, further comprising not triggering the second event in response to the time period being less than the predetermined time period.

17. The method of claim 15, further comprising registering the predetermined time period to an event manager.

18. The method of claim 15, further comprising adjusting the time period corresponding to the second event in response to the completion of the operation of the second event.

19. The method of claim 14, further comprising triggering a third event together with the first event; wherein the second event and the third event are registered to an event manager and have equal predetermined time period.

20. The method of claim 14, wherein the first event is a timing critical event and the second event is a non-timing critical event.
